(19) United States
(12) Patent Application Publication
(10) Pub. No.: US 2005/0010911 A1
(43) Pub. Date: Jan. 13, 2005

(54) Shared library system and method of building the system

(75) Inventors: Woon-Gi Kim, Suwon-si (KR); Jong-Il Park, Yeongtong-gu (KR)

Correspondence Address: F. CHAU & ASSOCIATES, LLC, 130 WOODBURY ROAD, WOODBURY, NY, 11797, US

(73) Assignee: SAMSUNG ELECTRONICS CO., LTD.

(21) Appl. No.: 10/889,431

(22) Filed: Jul. 12, 2004

(30) Foreign Application Priority Data
Jul. 12, 2003 (KR) 2003-47538

(51) Int. Cl. G06F 9/45

(52) U.S. Cl. 717/140; 717/162

(57) ABSTRACT

A shared library system and method of building the system are disclosed. A run-time loader and a compiler are modified, and a pattern of a previous shared library is changed using a library builder. Furthermore, by using a data section base register and a global offset table of a data section, it is possible to use a shared library even without a memory management unit.

### BACKGROUND OF THE INVENTION

This application claims priority from Korean Patent Application No. 2003-47538, filed on Jul. 12, 2003, in the Korean Intellectual Property Office, the disclosure of which is incorporated herein in its entirety by reference.

1. Field of the Invention

The present invention relates to a shared library system in which a plurality of application programs share one library instance, and more particularly, to a shared library system and method of building the system such that it is possible to use a shared library without a memory management unit (MMU).

2. Description of the Related Art

in general, a library is made up of a code and a data section for data used in the code. A library may be divided into a static library and a shared library according to whether a plurality of application programs share and use a library code. For a static library (usually *.a type file), a library code is duplicated and used with an application program in a linking step. For a shared library (usually *.so type file), a library code instance is shared and used among application programs at run-time. Likewise, in a system using a shared library, duplication of a library code is not generated in a linking step. The target of a shared library is to independently supply each data section to each program sharing a library code. Therefore, through the use of a shared library, it is possible to dramatically reduce consumption of random access memory (RAM) and flash memory.

A shared library is divided into a statically linked shared library and a dynamically linked shared library according to the time when complete linking, that is, symbol address binding, is performed. In general, a shared library is a dynamically linked shared library. In a dynamically linked shared library, actual symbol address binding is performed while loading a program at run-time. Thus, an application program does not have to be newly built even though the contents of a library are changed after an application program is built. Instead, overhead for binding a symbol at run-time occurs. However, in a statically linked shared library, actual symbol address binding is performed at linking-time. Therefore, if a library is changed, all application programs referring to the library have to be compiled again. Even so, run-time overhead is much less than that of a dynamically linked shared library.

In a system with a memory management unit (MMU), since it is possible for a plurality of processes to share a page through virtual memory mapping, it is relatively easy to use a shared library. In a conventional system without an MMU, since it is impossible for the plurality of processes to share a page, it is difficult to use a shared library. Recently, systems without an MMU, such as uCLinux™ have grown in popularity. Thus, it is desirable that such a system utilize a shared library for memory efficiency.

### SUMMARY OF THE INVENTION

The present invention provides a shared library system without a memory management unit (MMU) where it is possible to use a statically linked shared library.

The present invention also provides a method of constructing the shared library system without an MMU.

The present invention also provides a method of using a shared library in the shared library system without an MMU.

The present invention also provides a method of building a shared library in the shared library system without an MMU.

The present invention also provides a computer readable medium having a computer readable program code unit, which records the method of constructing the shared library system without an MMU.

The present invention also provides a computer readable medium having a computer readable program code unit, which records the method of using the shared library.

The present invention also provides a computer readable medium having a computer readable program code unit, which records the method of building the shared library.

According to an aspect of the present invention, there is provided a shared library system without an MMU including: a data section base register in which one of a data section start address of an application program and a data section start address assigned to the application program in shared libraries is established; a compiler which compiles a source code type program and libraries with a position independent code (PIC) option and defines functions included in the libraries so that the data section start address assigned to the application program by the libraries is established in the data section base register; a shared library builder which, by using the compiled libraries, generates the shared libraries, whose codes and data section are shared with a plurality of programs and exist as symbols in every library, and address libraries, which have symbol address information for binding symbol addresses to the programs; an application program builder which changes a compiled program into an execution file type application program by locating codes, data, and a data section table, which defines the data section start address assigned to the application program in the shared libraries, of the compiled program according to a linker script; and a run-time loader which loads the application program and the shared libraries in a memory and, when the shared libraries are loaded in the memory, decides final addresses of the symbols according to the result of a necessary address relocation by symbol relocation types included in the symbol address information. It is preferable that the data section includes a global offset table (GOT), which is a pointer table about global data, and a data field including the global data, and the data section start address is a GOT start address, and the application program refers to the global data using the GOT.

According to another aspect of the present invention, there is provided a method of building a shared library system without an MMU having a data section base register in which a data section start address, to which an application program refers, is established, including: (a) compiling a library to be shared with a PIC option and defining, in each function of the library to be shared, while compiling, that the data section start address assigned to a program to be executed is established in the data section base register; (b) generating, by using the compiled libraries, a shared library, whose actual codes and data exist in every library, and an address library which only has address information of symbols for binding symbol addresses to the application program; (c) compiling a program with the PIC option; (d) changing the compiled program into an execution file type application program by locating codes, data, and a data section table, which indicates the data section start address assigned to the application program in the shared libraries, of the compiled program according to a linker script; and (e) loading the shared libraries built for executing the application program in the memory.

According to another aspect of the present invention, there is provided, in a shared library system without an MMU having a data section base register in which a data section start address, to which an application program refers, is established, a method for the application program to use a shared library loaded in a memory, including: (a) if the application program calls for a function of the shared library, establishing the data section start address assigned to the application program in the shared library in the data section base register; and (b) performing the called function by the application program accessing an address established in the data section base register.

According to another aspect of the present invention, there is provided a method of building a shared library in a shared library system without an MMU, including: (a) compiling a library to be shared with a PIC option; (b) re-establishing a library name by assigning a unique number as an identification (ID) to the library to be shared; (c) relocating a plurality of object files included in the compiled library into one object file; (d) converting an object file format of step (c) so as to fit a target system, and generating the format converted object file as the shared library with codes and data to be shared; and (e) generating an address library in which addresses of the symbols per object file are defined, wherein the step of generating comprises extracting each position information and address information of symbols from the compiled library and shared library.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic block diagram of an embodiment of a shared library system without a memory management unit (MMU) according to the present invention;

FIG. 2 is a flowchart of an embodiment of a building procedure and a method of using a shared library of a shared library system without an MMU shown in FIG. 1;

FIG. 3 shows a building procedure of a shared library using a library builder;

FIG. 4 shows an embodiment of a symbol address format defined by the gensym utility shown in FIG. 3;

FIG. 5 shows a linker script including a FLAT binary relocation table;

FIG. 6 is a detailed drawing of a linker script of an application program; and

FIG. 7 describes a procedure in which an application program calls a function defined in a shared library while executing a program.

### DETAILED DESCRIPTION OF THE INVENTION

Illustrative embodiments of the invention are described below. In the interest of clarity, not all features of an actual implementation are described in this specification. It will be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims. It should be understood that the systems and methods described herein may be implemented in various forms of hardware, software, firmware, or a combination thereof.

It is understood that a shared library system of the present invention preferably uses a statically linked shared library, since it is important to reduce overhead of run-time in a built-in system.

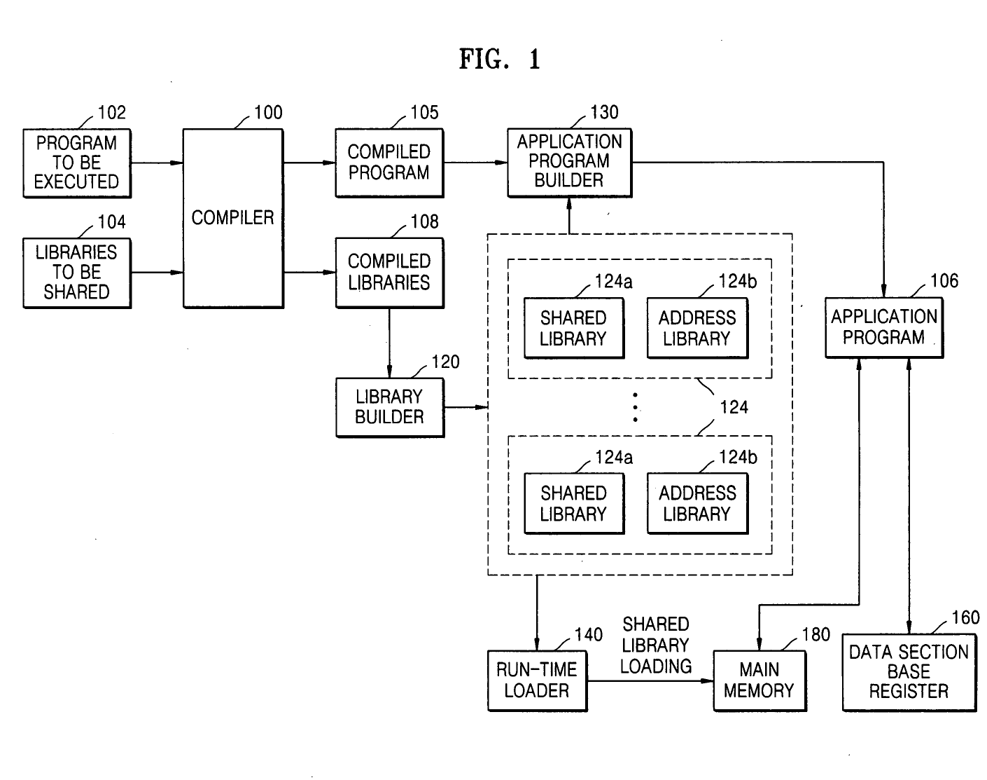

FIG. 1 is a schematic block diagram of an embodiment of a shared library system without a memory management unit (MMU) according to one embodiment of the present invention. The shared library system comprises a compiler 100, a library builder 120, an application program builder 130, a run-time loader 140, and a data section base register 160. For convenience of description, a main memory 180 is also shown.

The compiler 100 compiles a program to be executed 102 and libraries to be shared 104 with a predetermined option, that is, a position independent code (PIC) option, and then generates a compiled program 105 and compiled libraries 108. In actuality, when compiling a source code of the program to be executed 102 and the libraries to be shared 104, a PIC may be generated easily with a -fpic option. By compiling the program to be executed 102 and the libraries to be shared 104 with the PIC option in the compiler 100, an address of a memory loading a library does not have to be fixed in the shared library system without an MMU. That is, since, in the PIC, callings of every function are achieved with a pointer counter (PC) -relative branch or jump, the callings can be executed without regard to positions of codes loaded in a memory; therefore, an address to which a library is loaded does not have to be fixed. Also, the compiler 100 compiles the libraries to be shared 104 so that a data section start address assigned to the program to be executed 102 in a prologue of each function of a library is established in the data section base register 160. The compiler 100 assigns a unique number to each shared library as an Identification (ID), and establishes and compiles each name of the libraries as libID.so. For example, in a case where the number of shared libraries is 3, names of the libraries may be established as lib1.so, lib2.so, lib3.so, respectively.

By using the libraries 108 compiled by the compiler 100, the shared library builder 120 generates a shared library 124a and an address library 124b for every shared library. The shared library 124a is a library with actual codes and a data section. The shared library 124a is loaded in the main memory 180 by the run-time loader 140 to be shared with a plurality of application programs. The data section includes a Global Offset Table (GOT), which is a pointer table of global data, and a data field. The GOT is located just before the data field. At this time, the shared library 124a is a compiled library, which is relocated as an object file, including a plurality of object files. The address library 124b only has address information of a plurality of symbols without actual codes and data, and exists for binding symbol addresses to the application program 106. Each of the symbols comprises names of functions and global variables included in the object file. The address library 124b is not loaded in the main memory 180, but is used only when building the application program 106. At this time, a symbol address must include information needed when the run-time loader 140 loads the shared library 124a in the main memory 180. For example, the symbol address may include information on symbols in the object file or symbols in the shared library, and information on address relocation.

By locating the codes, the data, and the data section table of an application program according to a linker script, the application program builder 130 changes the compiled program 105 into the execution file type application program 106. The data section table shows start addresses of data sections assigned to the program to be executed 102 by the shared libraries 124a. In the present invention, the linker script is defined so that the data section table showing a data section start address of each library is located just before the data section. The linker script is described in greater detail below with reference to FIG. 6.

The run-time loader 140 loads the application program 106 and the shared libraries 124a into the main memory 180. When the run-time loader 140 loads the shared libraries 124a, the run-time loader 140 performs necessary address relocation according to a symbol relocation type included in symbol address information, and finally decides an address of the symbol. The address relocation of a symbol is described in greater detail below with reference to FIG. 4.

In the data section base register 160, one of the data section start address of the application program 106 and the data section start address of the shared libraries 124a loaded in the main memory 180 is established. As described above, the data section has a pattern where a GOT is located just before a global data field; therefore, the data section start address is the start address of the GOT. A stack limit (sl) register of an application reference model (ARM) may be used as the data section base register 160. If the application program 106 is executing a program with reference to a self data section (not a library) in the data section base register 160, the data section start address of the application program 106 is established. However, if the application program 106 calls for a function defined in the shared libraries 124a, according to a prologue definition of the called function, the data section start address assigned to the application program 106 by the shared libraries 124a is established in the data section base register 160. Likewise, by using the data section base register 160, the shared libraries 124a can guarantee an independent data section for each application program without an MMU. That is, if a PIC is used in a system without an MMU, it is possible to share codes of a shared library. However, it is still impossible to provide an independent data section to each application program. In the PIC, since all static data access with PC-relative branch or jump, relative offsets of codes and data sections must be constant and offsets of the library codes and data sections assigned to a plurality of application programs must be constant. However, in the shared library system according to the present invention, before the application program 106 executes a function of the shared libraries 124a, the application program 106 is compiled so that the data section address to which the application program 106 refers is loaded in the data section base register 160. Therefore, the offsets of the library codes and the data sections assigned to the plurality of application programs do not have to be constant, and independent data sections can be supplied to the plurality of application programs. That is, when the application program 106 accesses the data section assigned to itself, the application program 106 accesses the data section with reference to a value of the data section base register 160, thereby guaranteeing an independent data section to each application program 106.

By using the data section base register 160, it is possible to supply static data per application program 106 independently, but it is difficult for the application program 106 to access global data without code relocation. The global data is shared and used between the application program 106 and libraries, or among libraries. In a statically linked shared library, since an address of the global data is decided at a loading step, the global data reference must be relocated when a program is loaded. For this, the GOT, which is a pointer table for global variables, is used. By using a pointer assigned to the data section, codes are generated so as to refer to global data indirectly, and, if data of global variables are finally decided during a loading progress, the applicable items of the GOT are relocated according to the data. As described above, since the GOT exists in the data section, relocation of the GOT can be achieved without regard to relocation of a code field.

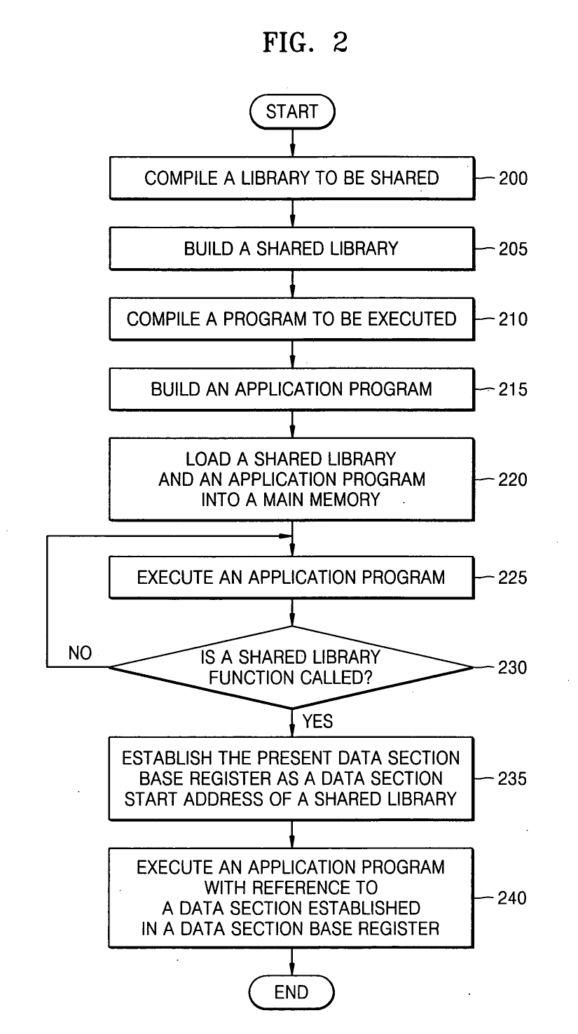

FIG. 2 is a flowchart of an embodiment of a building procedure and a method of using a shared library of a shared library system without an MMU shown in FIG. 1.

With reference to FIGS. 1 and 2, the compiler 100 compiles the libraries to be shared 104 in step 200. At this time, the compiler 100 compiles the libraries to be shared 104 with the PIC option, and establishes each name of libraries as libID.so by assigning a unique number as an ID to each shared library. Likewise: a unique number assigned to each library is used to search for the data section start address assigned to each library in the data section table of the application program 106. A more detailed description will be made below with reference to FIG. 6. Also, the compiler 100 compiles the libraries to be shared 104 so that the data section start address assigned to the application program 106 in a prologue of each function of the shared libraries is established in the data section base register 160.

By using compiled libraries 108, the library builder 120 generates the shared libraries 124a, whose actual codes and data exist in every library, and the address libraries 124b, which only have address information of symbols for binding symbol addresses to the application program 106, in step 205.

The compiler 100 compiles the program to be executed 102 in step 210. The compiler 100 compiles the program to be executed 102 with the PIC option, such as the libraries to be shared 104.

By locating codes, data, and a data section table of an application program according to a linker script, the application program builder 130 changes the compiled program 105 into the execution file type application program 106 in step 215.

The run-time loader 140 loads the built shared libraries 124a and the built application program 106 in the main memory 180 in step 220. When the run-time loader 140 loads the shared libraries 124a in the main memory 180, the run-time loader 140 performs necessary address relocation according to a symbol relocation type included in a symbol address of the address libraries 124b, and finally decides the symbol address.

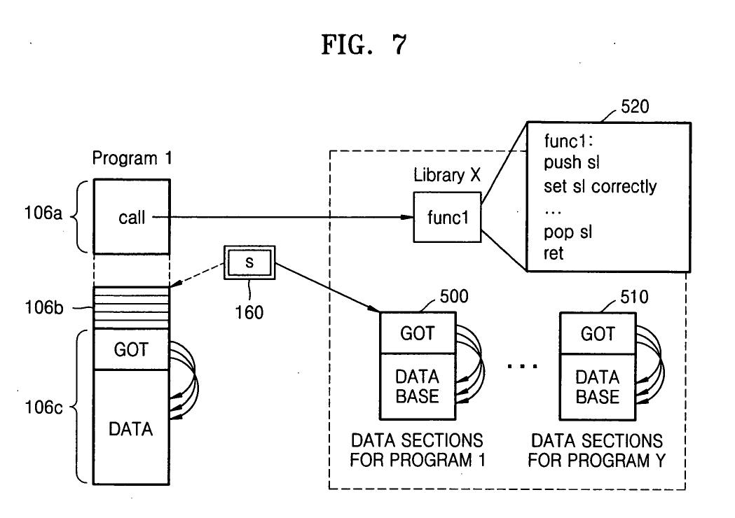

The application program 106 is executed in step 225. If the application program 106 is executing a program with reference to a self data section, the data section base register 160 is established as the data section start address of the application program 106, that is, a GOT start address. However, if the application program 106 calls a function of the shared libraries 124a in step 230, the data section start address assigned to the application program 106 in the shared libraries 124a is established in the data section base register 160 according to a prologue definition of a shared library function in step 235. The application program 106 may access the data section assigned to the application program 106 by an address established in the data section base register 160. The application program 106 indirectly refers to global data by using the GOT, which is a pointer table of global data included in the data section, and executes a function called from the shared libraries 124a in step 240. A more detailed description of the operation performed in steps 235 and 240 is described below with reference to FIG. 7.

As described above, for using a shared library without an MMU, the present invention modifies the run-time loader 140 and the compiler 100, and changes the pattern of a previously shared library via the library builder 120. Furthermore, by using the data section base register 160 and the GOT of the data section, it is possible to use a shared library even without an MMU. In the case of a conventional system without an MMU, since an address of loading a library cannot be fixed, an independent data section cannot be assigned to an application program, and it is impossible to access global data without code relocation, it is difficult to use a shared library. However, a shared library system according to the present invention does not have to fix an address of loading a library by compiling the program to be executed 102 and the libraries to be shared 104 with a PIC option so that callings of every function are achieved with a PC-relative branch or jump. Also, by compiling the program to be executed 102 and the libraries to be shared 104 so that the data section start address to which the application program 106 refers is loaded in the data section base register 160 before the application program 106 processes library codes, independent data sections can be given to every application program 106. Also, the shared library system generates codes so as to refer to global data indirectly by using a pointer assigned to the data section, and relocates applicable items of the GOT if data of global variables are finally decided during a loading process. Since the application program 106 accesses global data by using the GOT of the data section, it is possible to access global data without code relocation. As the result of the above, since the shared library system according to the present invention solves the problems of the conventional system without an MMU, the shared libraries can be used without an MMU in the shared library system according to the present invention.

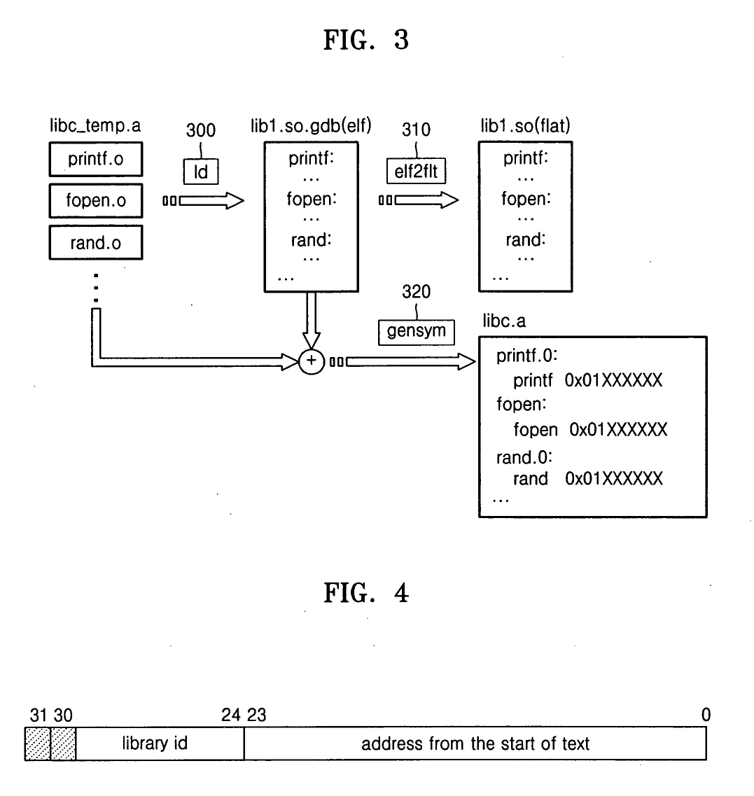

FIG. 3 shows a building procedure of a shared library by a library builder 120.

With reference to FIGS. 1 and 3, libc_temp.a is the compiled library 108 compiled by the compiler 100, and shows archives of objects included in a C library. Object files in these archives are compiled so that codes, which establish the data section start address (in the data section base register 160), to which the application program 106 refers, are included in a prologue of every object file by the compiler 100.

A linker 300 generates a library lib1.so.gdb that a plurality of object files included in a library libc_temp.a are relocated in a single object file. At this time, a file format of a lib1.so.gdb is an Executable Linking Format (ELF), and, using a format conversion utility 310, an ELF file must be adequately relocated so as to fit a target system. For example, if the target system is a uCLinux™, the format conversion utility 310 converts the ELF file lib1.so.gdb into a FLAT file format lib1.so. Likewise, a library, of which a file format is converted so as to fit a target system, is called a shared library. As described above, shared libraries 124a are libraries with actual codes and data. The shared libraries 124a are loaded in the main memory 180 by the run-time loader 140, and are shared with the plurality of application programs 106.

Since the present invention is a statically linked shared library system, an object to be statically linked to the application program 106 is necessary. For this, a gensym utility 320 generates a file libc.a, which only has address information of symbols for binding symbol addresses to an application program without actual codes and data. The libc.a is a symbol address library, which only defines export symbols except library codes (i.e., non-library export symbols). At this time, it is important that each symbol is adequately divided and defined into a plurality of object files (*.o). If all symbols are defined in one object file, since all symbols in the libraries are included in one module, an unnecessary duplicate declaration error may be generated. Therefore, the gensym utility 320 extracts necessary information, that is, the information of the object file including symbols from an archive libc_temp.a, before the archive is relocated as one object file for dividing and defining these symbols into a plurality of object modules. That is, the gensym utility 320 obtains addresses of symbols from the lib1.so.gdb in the C library and obtains information of an object module, in which symbols must be defined, from the libc_temp.a, which is an archive prior to relocation. The gensym utility 320 divides and defines global symbols into the plurality of object modules, like in the libc.a. In this case, the addresses of symbols indicate offsets in a lib1.so.gdb of the symbols. That is, contents of the symbol address library libc.a include symbol names exported by the C library and the offsets in the lib1.so.gdb of the symbols. The library libc.a does not include any codes other than those mentioned above. Therefore, the application program 106 referring to the C library is linked with a library lib1.so by referring to only offsets of symbols defined when the libc.a is linked. That is, codes in duplicate are not generated, and symbol addresses, that is, only symbol offsets, are bound. Symbol addresses defined in the libc.a must be relocated by the run-time loader 140 according to addresses in the main memory 180 in which a run-time library is loaded. For this, symbol addresses must be formatted so that symbol information, that is, information showing that the symbols are in an object file or in shared libraries, is included in the symbol addresses.

FIG. 4 shows an embodiment of a symbol address format defined by the gensym utility 320 shown in FIG. 3.

A symbol address is expressed in 32 bits (4 Bytes), the lower 24 bits of the 32 bits show an actual address of a symbol. In this case, the total size of an application program and libraries cannot exceed 16 MB (=2²⁴ Bytes). If the size of a library exceeds this limitation, the library must be divided. Six bits from the 24th bit to the 29th bit are given a unique number to the library in which a symbol is defined, that is, an ID. As described above, the ID is given to each library in a compiling process. In this case, the number of libraries that can be used simultaneously is at max 64 (=2⁶). And the highest 2 bits represent a relocation type, which is largely divided into 3 classes. A first relocation type is a case where the highest 2 bits are 00, which means that a symbol address is an absolute address value which needs to be modified when loading, and is mainly shown in a data section. A second relocation type is a case where the highest 2 bits are 01, which means that the symbol address must be assigned to an address of the GOT, that is, the data section start address. A third relocation type is a case where the highest 2 bits are 11. This means that the symbol address is a target address of branch instructions, and is used to modify a reference address of a function of calling a dynamic library. The reference address is decided while loading. To reiterate, in a case of the first relocation type, the symbol address is only relocated to an absolute address of the main memory 180. Otherwise, additional work is necessary. That is, in a case of the second relocation type, the symbol address must be relocated to an assigned data section start address, that is, a start address of the GOT. And, in the case of the third relocation type, direct modification of codes into a format to fit branch instructions of a system is needed. For example, in an ARM, since the highest 8 bits of every branch instruction decide a branch type and the remaining lower 24 bits show a branch offset, a symbol address may be modified to fit an appropriate system on the basis of the relocation information.

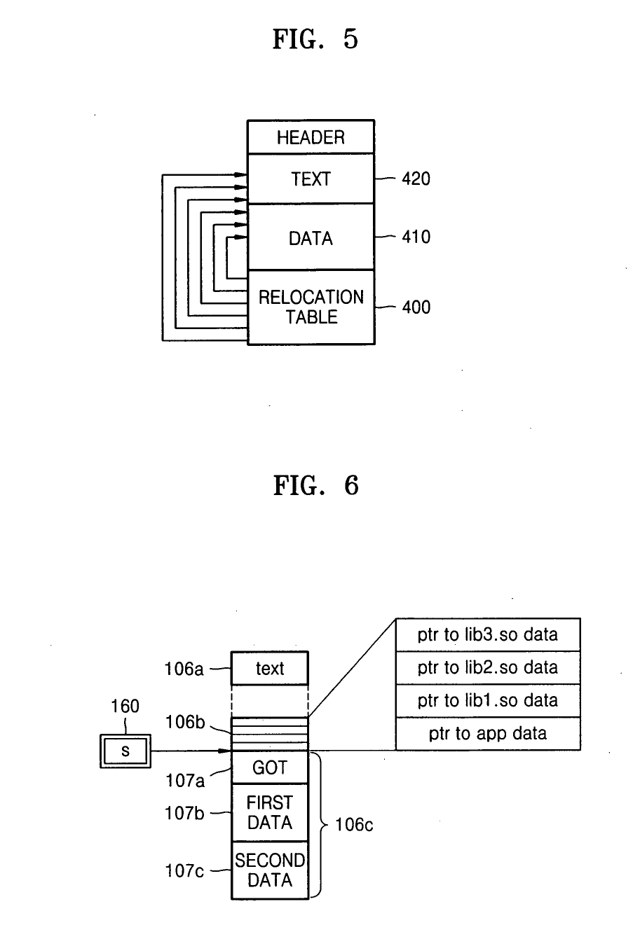

A symbol address format described above is also equally applied to entries of a FLAT binary relocation table 400 of a uCLinux™ system. The FLAT binary relocation table 400 is located next to a data section 410 as shown in FIG. 5, and each entry of the FLAT binary relocation table 400 indicates codes and data which need to be relocated by the run-time loader 140.

The run-time loader 140 generally (1) loads the shared libraries 124a, to which the application program 106 refers, in the main memory 180; (2) relocates addresses of symbols included in the shared libraries 124a; and (3) guarantees sharing of library codes. That is, in a case where the plurality of application programs 106 use one shared library 124a simultaneously, a library code loads only one instance in the main memory 180. The main reason for the run-time loader 140 to perform these roles is to detect a reference to a library among entries in the GOT table and the relocation table. This may be easily obtained from an address format of a symbol and a relocation entry shown in FIG. 4. For example, when an ID of the application program 106 is assigned as 0 and IDs of the shared libraries 124a are assigned as predetermined serial numbers starting from 1, if the 24^{th} to the 29^{th} bits of an address value, that is, bits showing a library ID, are not all 0, the address indicates the reference to a library. If the reference for a library which is not loaded in the main memory 180 is detected, the run-time loader 140 loads an applicable library in the main memory 180, performs necessary relocation, and decides addresses of the symbols on the basis of the loading information.

FIG. 6 is a detailed drawing of linker script of the application program 106. A text 106a is a field in which a function code is defined. A data section table 106b shows the data section start addresses assigned to the shared libraries 124a to which the application program 106 refers. In a data section 106c, a GOT 107a is a pointer table of global variables, a first data 107b is a field in which the global variables are defined, and a second data 107c is a field in which local variables are defined. FIG. 6 shows the data section table 106b in a case where the number of the shared libraries 124a, to which the application program 106 refers, is three. The data section table 106b is located just before the data section 106c, and the name of each library is converted into a libID.so type. Each shared library 124a is given an ID of 1, 2, 3, . . . , and the application program 106 is assigned an ID of 0. These IDs are used for finding a position of a data section assigned to the application program 106. If the size of an address is 4 bytes, an address of the data section assigned to the application program 106 in each library may be obtained from the formula (−4*ID−4). For example, a data section of a library whose ID is 1 is obtained by subtracting 8 bytes from an address indicated by the present data section base register 160. If the present data section base register 160 indicates a data section of the application program 106 and the present data section base register value is sl, the data section start address information of the application program 106, ‘ptr to app data,’ is obtained from the address of sl-4, and the data section address of the library whose ID is 1, ‘ptr to lib1.so data,’ is obtained from the address of sl-8. Likewise, the data section address of the library whose ID is 2, ‘ptr to lib2.so data,’ is obtained from the address of sl-12, and the data section address of the library whose ID is 3, ‘ptr to lib3.so data,’ is obtained from the address of sl-16. Also, for convenience of library retrieval, a library name of a libID.so type must exist in a/lib directory. For example, if a unique number 1 is assigned to libc, a C shared library object code with a name of a lib1.so must exist in a/lib directory.

FIG. 7 describes a procedure in which the application program 106 calls a function defined in a shared library while performing a program.

With reference to FIGS. 6 and 7, a shared library X contains data sections 500 to 510 of application programs. In the shared library X, the data sections 500 to 510 are assigned to the application programs 1 through Y, respectively. That is, a function code, such as func1, is shared by every application program, and global data is assigned to each application program. If the application program 1 performs by referring to the data section of the application program, the data section start address of the application program, that is, the GOT start address, is established in the data section base register 160. However, if the application program 1 calls the function code func1 defined in the library X, according to an instruction ‘push sl’ of a prologue 520 of the function code func1, the present data assigned to the data section base register 160 is stored in another storage space. According to an instruction ‘set sl . . . ,’ the application program obtains the start address of the data section 500 assigned to the application program 1 in the shared library X with reference to the data section table 106b of the application program, and establishes the start address in the data section base register 160. Also, if execution of the function code fund is finished, according to an instruction ‘pool sl,’ the data stored in the other storage space is established in the data section base register 160 again.

As described above, the run-time loader and the compiler are modified so as to refer to the shared libraries while executing a program, and the pattern of the previous shared libraries is modified through the library builder. By using the shared library through this procedure, memory usage of a system may be reduced, and, eventually, manufacturing costs of the system may be reduced.

The present invention may be embodied in a general-purpose computer by running a program from a computer readable medium, including but not limited to storage media such as magnetic storage media (ROMs, RAMs, floppy disks, magnetic tapes, etc.), optically readable media (CD-ROMs, DVDs, etc.), and carrier waves (transmission over the internet). The present invention may be embodied as a computer readable medium having a computer readable program code unit embodied therein for causing a number of computer systems connected via a network to effect distributed processing.

As described above, according to a shared library system without an MMU and a method of building the system, by modifying the compiler, the run-time loader, and the library builder, the shared library may be used without hardware, such as an MMU, and by reduction of memory usage resulting therefrom, manufacturing costs of a system can be reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A shared library system comprising:
a data section base register in which one of a data section start address of an application program and a data section start address assigned to the application program in shared libraries is established;
a compiler which compiles a source code type program and libraries with a position independent code (PIC) option and defines functions included in the libraries so that the data section start address assigned to the application program by the libraries is established in the data section base register;
a shared library builder which, by using the compiled libraries, generates the shared libraries, whose codes and data section are shared with a plurality of programs and exist as symbols in every library, and address libraries, which have symbol address information for binding symbol addresses to the programs;
an application program builder which changes a compiled program into an execution file type application program by locating codes, data, and a data section table, which defines the data section start address assigned to the application program in the shared libraries, of the compiled program according to a linker script; and
a run-time loader which loads the application program and the shared libraries in a memory and, when the shared libraries are loaded in the memory, decides final addresses of the symbols according to the result of a necessary address relocation by symbol relocation types included in the symbol address information;
wherein the data section comprises a global offset table (GOT), which is a pointer table about global data, and a data field including the global data, and the data section start address is a GOT start address, and the application program refers to the global data using the GOT.

2. The shared library system of claim 1, wherein the compiler gives serial numbers starting from 1 as identifications (IDs) to the libraries, respectively, and re-establishes names of the libraries on the basis of the given IDs.

3. The shared library system of claim 2, wherein the re-established library names exist in a predetermined directory for convenience of library retrieval.

4. The shared library system of claim 2, wherein the linker script is defined so that the data section table is located just before the data section,
and when the size of an address is n Bytes, the application program obtains the data section start address of the shared library, whose ID is m, from a formula (sl-n*m-n),
wherein sl is the data section start address of the application program.

5. The shared library system of claim 1, wherein the shared library builder comprises:
a linker which relocates a plurality of object files included in the compiled libraries in a single object file;
a format conversion utility which converts a format of the object file so as to fit a target system and generates the format-converted object file as the shared library; and
a gensym utility which extracts position information of the object file including the symbols and offsets of the symbols in the shared library as symbol address information from the compiled libraries, and generates the address library by using the position information, wherein symbol addresses are defined in the address library in the object file in which the symbols are located.

6. The shared library system of claim 5, wherein the address library defines address information of non-library export symbols.

7. The shared library system of claim 1, wherein a format of the symbol address comprises:
a first field of p bits indicating the symbol address;
a second field of q bits indicating an ID of a library in which the symbol is defined; and
a third field of r bits indicating an address relocation type while loading the shared libraries in the main memory.

8. The shared library system of claim 7, wherein the size of one of the application program and the library is less than or equal to 2^{m} bits, and if the size of the library exceeds 2^{m} bits, the library is divided so that the size of the library is less than or equal to 2^{m} bits.

9. The shared library system of claim 7, wherein the address relocation type comprises:
a first relocation type showing that the address of the symbol must be relocated to an absolute address of the main memory when the address of the symbol is loaded in the main memory;
a second relocation type showing that the address of the symbol must be substituted with the GOT start address, which is the data section start address; and
a third relocation type showing that the address of the symbol is a target address of a branch instruction and must be modified to a format to fit the branch instruction of the target system.

10. The shared library system of claim 7, wherein if the target system is uCLinux™, entries of a FLAT binary relocation table have the same address format as that of the symbol.

11. A method of building a shared library system, which has a data section base register in which a data section start address, to which an application program refers, is established, comprising:
(a) compiling a library to be shared with a PIC option and defining, in each function of the library to be shared, while compiling, that the data section start address assigned to a program to be executed is established in the data section base register;
(b) generating, by using the compiled libraries, a shared library, whose actual codes and data exist in every library, and an address library which only has address information of symbols for binding symbol addresses to an is application program;
(c) compiling a program with the PIC option;
(d) changing the compiled program into an execution file type application program by locating codes, data, and a data section table, which indicates the data section start address assigned to the application program in the shared libraries, of the compiled program according to a linker script; and
(e) loading the shared libraries built for executing the application program in the memory.

12. The method of claim 11, wherein the compiler assigns serial numbers starting from 1 as IDs to the libraries, respectively, and re-establishes names of the libraries on the basis of the assigned IDs.

13. The method of claim 12, wherein the linker script is defined so that the data section table is located just before the data section,
and when the size of an address is n bytes, the application program obtains the data section start address of the shared library, whose ID is m, from a formula (sl-n*m-n),
wherein sl is the data section start address of the application program.

14. The method of claim 11, wherein (a) the data section comprises a GOT, which is a pointer table on global data, and a data field including global data, (b) the data section start address is a GOT start address, and (c) the application program refers to the global data using the GOT.

15. The method of claim 11, wherein a format of the symbol address comprises:
a first field of p bits indicating the symbol address;
a second field of q Bits indicating an ID of a library in which the symbol is defined; and
a third field of r Bits indicating an address relocation type while loading the shared libraries in the main memory.

16. The method of claim 15, wherein the size of one of the application program and the library is less than or equal to 2^{m} Bits, and if the size of the library exceeds 2^{m} Bits, the library is divided so that the size of the library does is less than or equal to 2^{m} Bits.

17. The method of claim 15, wherein the address relocation type comprises:
a first relocation type showing that the address of the symbol must be relocated to an absolute address of the main memory when the address of the symbol is loaded in the main memory;
a second relocation type showing that the address of the symbol must be substituted by the GOT start address, which is the data section start address; and
a third relocation type showing that the address of the symbol is a target address of a branch instruction, and must be modified into a format to fit the branch instruction of the target system.

18. The method of claim 15, wherein if the target system is uCLinuX™, entries of a FLAT binary relocation table have the same address format as that of the symbol.

19. The method of claim 15, wherein when the shared libraries are loaded in the memory, according to the result of performing necessary address relocation by the relocation type of the symbol, a final address of the symbol is decided.

20. A computer readable medium having a computer readable program code unit, which records the method of claim 11.

21. A method of using a shared library in a shared library system, which has a data section base register in which a data section start address, to which an application program refers, is established, comprising:
(a) if the application program calls a function of the shared library, establishing the data section start address assigned to the application program in the shared library in the data section base register; and
(b) performing the function called by the application program by accessing the address established in the data section base register.

22. The method of claim 21, wherein step (a) comprises:
(a1) if the application program calls a function of the shared library, storing the data section address established in the data section base register in another storage space;
(a2) with reference to a data section table of the application program, establishing the data section start address assigned to the application program in the shared library to the data section base register;
(a3) performing the function called by the application program with reference to global data through a GOT access referring to the address established in the data section base register; and
(a4) if execution of the called function is finished, re-establishing the data section address stored in the another storage space in step (a1) to the data section base register.

23. A computer readable medium having a computer readable program code unit, which records the method of claim 21.

24. A method of building a shared library in the shared library system, comprising:
(a) compiling a library to be shared with a PIC option;
(b) re-establishing a library name by assigning a unique number as an ID to the library to be shared;
(c) relocating a plurality of object files included in the compiled library to a single object file;
(d) converting a format of the object file of step (c) so as to fit a target system and generating the format converted object file as the shared library with codes and data to be shared; and
(e) generating an address library in which an address of the symbol per object file is defined, wherein the step of generating comprises extracting each position information and address information of symbols from the compiled library and shared library,.

25. The method of claim 24, wherein the address library only defines address information of non-library export symbols.

26. The method of claim 24, wherein when compiling, each function of the library to be shared is defined so that the data section start address assigned to the application program is established in a predetermined register.

27. The method of claim 24, wherein step (e) comprises:
(e1) extracting the position information of the object file including the symbols from the compiled library;
(e2) extracting offsets of symbols in the shared library as the symbol address information; and
(e3) generating the address library in which the address of the symbol is defined in the object file in which the symbols are located, wherein the step of generating comprises using the position information.

28. A computer readable medium having a computer readable program code unit, which records the method of claim 24.
